(19) United States
(12) Patent Application Publication
(10) Pub. No.: US 2022/0146102 A1
(43) Pub. Date: May 12, 2022

(54) MULTI-STATION PARALLEL SYNCHRONOUS AND ASYNCHRONOUS CONTROL METHOD AND SYSTEM FOR DETACHABLE GAS OVEN

(71) Applicant: JIANGSU JIUHUI TECHNOLOGY CO., LTD., Taizhou (CN)

(72) Inventors: Lanyu YANG, Taizhou (CN); Tao CHEN, Taizhou (CN); Xifeng YANG, Taizhou (CN); Jiuhui BIAN, Taizhou (CN); Wei GU, Taizhou (CN); Wenbin MA, Taizhou (CN); Ming HE, Taizhou (CN); Zhengbing ZHU, Taizhou (CN); Xuedan LIU, Taizhou (CN)

(73) Assignee: JIANGSU JIUHUI TECHNOLOGY CO., LTD., Taizhou (CN)

(21) Appl. No.: 17/161,682

(22) Filed: Jan. 29, 2021

Related U.S. Application Data
(63) Continuation of application No. PCT/CN2020/130268, filed on Nov. 20, 2020.

(30) Foreign Application Priority Data
Nov. 9, 2020 (CN) 202011241193.1

(51) Int. Cl. F24C 3/12; F24C 3/00; F24C 15/20; F27D 21/00

(52) U.S. Cl. CPC F24C 3/124; F24C 3/004; F27D 2019/0003; F27D 21/0014; F24C 15/2007

(57) ABSTRACT

A detachable multi-station parallel synchronous and asynchronous control system for a gas oven includes a controller, a plurality of temperature sensors, a solenoid valve, a stepper motor, and a remote control terminal. The plurality of temperature sensors are installed on a plurality of stations, respectively. The controller generates a control signal, and sends the control signal to a driver through a communication network, so that the driver generates a driving signal according to the control signal, and sends the driving signal to a multi-station coordinated control system. The multi-station coordinated control system controls the stepper motor and the solenoid valve of each station according to the drive signal. A sensor is configured to collect position information and speed information of a plurality of target motors and generate a detection signal. A method for using the detachable multi-station parallel synchronous and asynchronous control system is further provided.

### CROSS REFERENCE TO THE RELATED APPLICATIONS

This application is the continuation application of International Application No. PCT/CN2020/130268, filed on Nov. 20, 2020, which is based upon and claims priority to Chinese Patent Application No. 202011241193.1, filed on Nov. 9, 2020, the entire contents of which are incorporated herein by reference.

### TECHNICAL FIELD

The present invention relates to the technical field of controllers, and in particular, to a multi-station parallel synchronous and asynchronous control method and system for a gas oven.

### BACKGROUND

There are basically two types of ovens, one is electric oven, and the other is gas oven. Gas ovens are widely used and are one of the most favorite cooking apparatus. With recent developments in wireless technologies, people are more and more like to remotely control the gas oven to work through a mobile phone, but the fixed controller of the gas oven cannot protect the gas oven.

In the prior multi-station parallel synchronous and asynchronous controllers for gas ovens, the controller cannot be quickly positioned and installed. It is, therefore, prone to generate heat when working for a long time, and cannot efficiently dissipate heat in time. This is unacceptable because it affects the temperature control during normal operations of the oven. Additionally, the sealing performance of the protective box is not satisfactory, and easy to cause the external water vapor to enter into the inside of the protective box with the wiring harness to damage to the controller. With controllers currently available, it is impossible to control two hobs to function concurrently. Therefore, it is desirable to develop a multi-station parallel synchronous and asynchronous controller for a gas oven.

### SUMMARY

### (1) Technical Problem to be Solved

With respect to the shortcomings in the prior art, the present invention provides a multi-station parallel synchronous and asynchronous control method and system for a gas oven, thereby facilitating fast installation of the controller, solving the problems of poor heat dissipation, the inconvenience of having to seal the air box, and the inability to control two hobs to work concurrently.

### (2) Technical Solutions

In order to achieve the above purpose, the technical solutions of the present invention are as follows:

The present invention provides a multi-station parallel synchronous and asynchronous control method for a detachable gas oven, including a controller, a plurality of temperature sensors, a solenoid valve, a stepper motor, and a remote control terminal.

The plurality of temperature sensors are installed on a plurality of stations, respectively.

The controller generates a control signal, and sends the control signal to a driver through a communication network, so that the driver generates a driving signal according to the control signal, and sends the driving signal to a multi-station coordinated control system.

The multi-station controls the stepper motor and the solenoid valve of each station according to the drive signal.

A sensor is configured to collect position information and speed information of a plurality of target motors and generate a detection signal.

A multi-station coordinated control signal is pre-established according to the detection signal, and the current driver adjusts the driving signal according to an adjusted control signal.

Preferably, the multi-station coordinated control system receives the driving signal and outputs a current control command. A current control loop is configured to generate a current signal to at least one target stepper motor in the target motors according to the current control command to control a position and a speed of each target stepper motor in the target motors.

Preferably, temperature control in the oven is divided into stepwise adjustment and stepless linear adjustment.

Preferably, the target stepper motor includes a master stepper motor and a plurality of slave stepper motors, and the master motor is configured to receive the current signal.

Preferably, the multi-station parallel synchronous and asynchronous control system further includes a remote control terminal, and the remote control terminal is configured to perform control after communicating with a communication module through a mobile phone.

Preferably, step S1: first, when the controller is installed, using a positioning rod to position a positioning base fixed by the controller, and then, twisting a fixing bolt to fix the positioning base on a surface of a mounting plate to quickly fix the controller inside a protective box;

step S2: when the controller dissipates the heat, activating an exhaust fan to extract and discharge the hot air inside the protective box, and driving by an intake fan to take the cold air from an outside into the protective box, and ventilating and dissipating the hot air emitted by the controller inside the protective box in time;

step S3: when a wiring harness of the controller is sealed, moving a compression spring upward through a connecting plate to transmit the wiring harness of the controller out of the inner wall of the protective box through a wiring harness hole, and then, releasing the connecting plate to tightly fit a sealing ring fixed by a sliding rod to the wiring harness of the controller through a rebound force of the compression spring to seal a surface of the wiring harness; and

step S4: when a hob is controlled to work, controlling the controller by an application of a mobile phone to drive the solenoid valve to ignite the hob, and transferring the temperature to the controller by the temperature sensors, and when the temperature is lowered, controlling a proportional valve by the solenoid valve to increase the temperature.

The present invention provides a network stability control system based on multi-station cooperated operation. A fixed base is fixedly connected to a side of the controller, and a fixing bolt is threadedly connected to the surface of the fixed base. An end of the fixing bolt is threadedly connected to a mounting plate, and the mounting plate is fixedly connected to the inner wall of the protective box. A positioning rod is fixedly connected to the surface of the mounting plate, and a positioning base is installed on the surface of the positioning rod. The positioning base is fixedly connected to a side of the controller. Two through slots are provided at sides of the protective box, respectively, and an exhaust fan and an intake fan are fixedly connected to inner walls of the two through slots, respectively. The inner wall of the controller is provided with a wiring harness hole, and a sealing ring is slidably connected to the inner wall of the wiring harness hole. A compression spring is fixedly connected to the surface of the protective box, and an end of the compression spring is fixedly connected to a connecting plate. A sliding rod is fixedly connected to the surface of the connecting plate, and an end of the sliding rod is fixedly connected to a sealing ring. The top of the protective box is fixed to a workbench, and the temperature sensors are fixedly connected to the front of the workbench. Two hobs and two solenoid valves are fixedly connected to the top of the workbench, respectively, and a proportional valve is fixedly connected to the top of the workbench.

Preferably, a connecting block is fixedly connected to the front of a sealing door. A fixing block is fixedly connected to the front of the protective box, and the fixing block is adapted to the inner wall of the connecting block. Two supporting bases are fixedly connected to the front of the protective box, and an inserting rod is slidably connected between inner walls of the supporting bases. The inserting rod is adapted to a size of the inner wall of the fixing block, and an end of the inserting rod is fixedly connected to a fixed handle.

Preferably, a supporting spring is sleeved on the surface of the inserting rod. One end of the supporting spring is fixedly connected to the supporting base, and the other end of the supporting spring is fixedly connected to a fixed ring. The fixed ring is fixedly connected to the surface of the inserting rod.

Preferably, the surface of the protective box is provided with a stabilizing groove. A stabilizing block is slidably connected to an inner wall of the stabilizing groove, and the stabilizing block is fixedly connected to a side of the connecting plate.

Preferably, the multi-station parallel synchronous and asynchronous control system further includes a food temperature sensor matched with the controller, and the food temperature sensor employs a pt100 temperature sensor.

### (3) Advantages

Compared with the prior art, the present invention provides a multi-station parallel synchronous and asynchronous controller for a gas oven, having the following advantages.

The multi-station parallel synchronous and asynchronous controller for the gas oven can control multiple hobs to work concurrently, and can also control operation of a single hob, thereby improving the working efficiency and increasing the practicability. The present invention can also realize menu-style storage and can be controlled remotely with a mobile phone. The device is a detachable device.

### BRIEF DESCRIPTION OF THE DRAWINGS

FIG. 1 is a system block diagram of the present invention;

FIG. 2 is a flow chart of the present invention;

FIG. 3 is a schematic diagram of the structure of the present invention;

FIG. 4 is a side view of the structure of the present invention;

FIG. 5 is an enlarged view of the portion A circled in FIG. 2 according to the present invention;

FIG. 6 is a schematic diagram of the connection between the protective box and the workbench according to the present invention;

FIG. 7 is a top view of the structure of the workbench according to the present invention;

FIG. 8 is a front view of the present invention;

FIG. 9 is an enlarged view of the portion B circled in FIG. 7 according to the present invention; and

FIG. 10 is a schematic diagram of the structure of the roasting stick according to the present invention.

In the figures: 1—controller; 2—fixed base; 3—fixing bolt; 4—mounting plate; 5—protective box; 6—fixing rod; 7—positioning base; 8—through slot; 9—exhaust fan; 10—intake fan; 11—threaded base; 12—connecting base; 13—wiring harness hole; 14—dust screen; 15—sealing ring; 16—compressed spring; 17—connecting plate; 18—sliding rod; 19—workbench; 20—temperature sensor; 21—hob; 22—solenoid valve; 23—proportional valve; 24—sealing door; 25—observation window; 26—connecting block; 27—fixing block; 28—supporting base; 29—fixed handle; 30—inserting rod; 31—supporting spring; 32—fixed ring; 33—stabilizing groove; 34—stabilizing block, 35—roasting stick, 36—food temperature sensor.

### DETAILED DESCRIPTION OF THE EMBODIMENTS

The technical solutions in the embodiments of the present invention will be clearly and completely described below in conjunction with the drawings in the embodiments of the present invention. Obviously, the described embodiments are only a part of the embodiments of the present invention, rather than all the embodiments. Based on the embodiments of the present invention, all other embodiments obtained by those skilled in the art without creative work shall fall within the scope of protection of the present invention.

### Embodiment

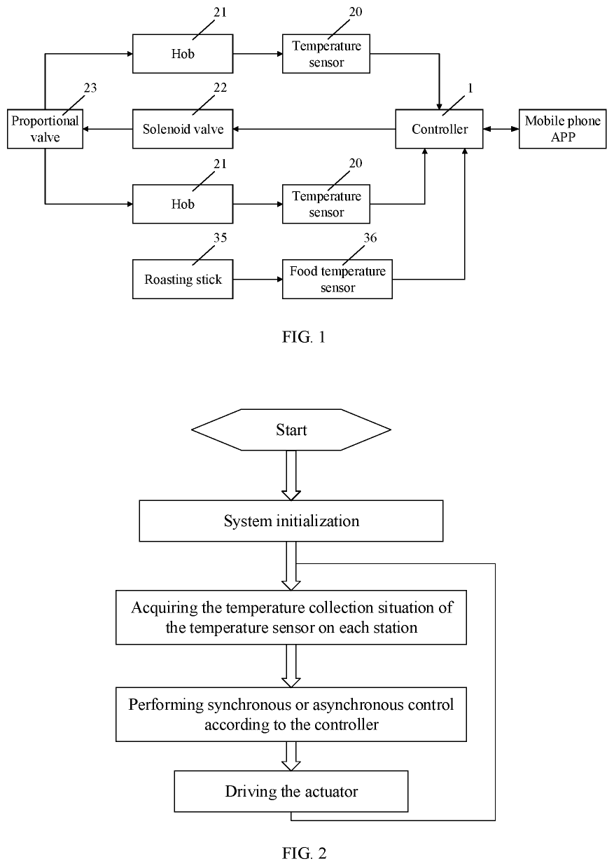

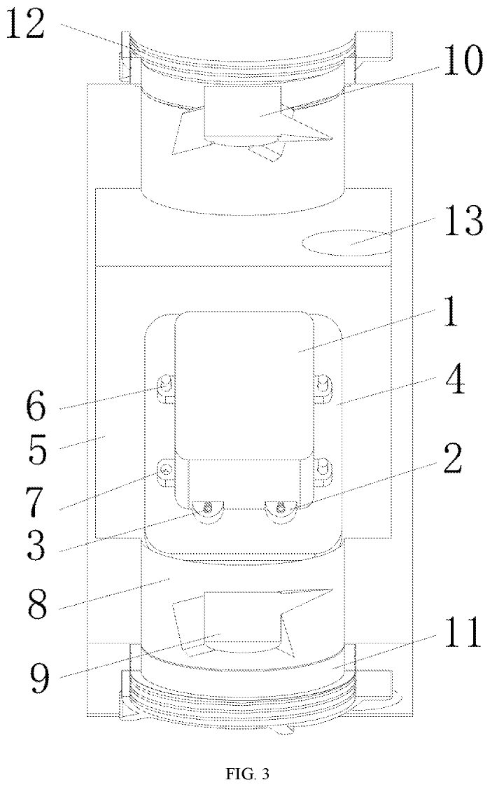

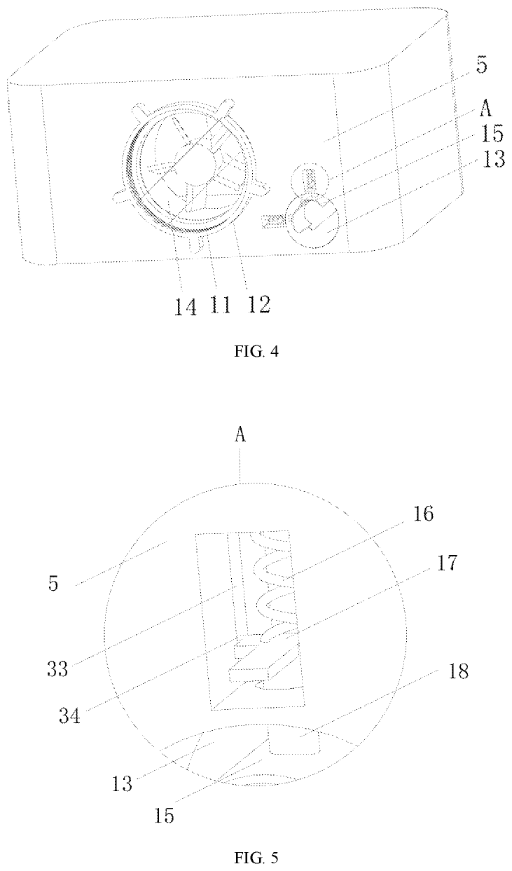

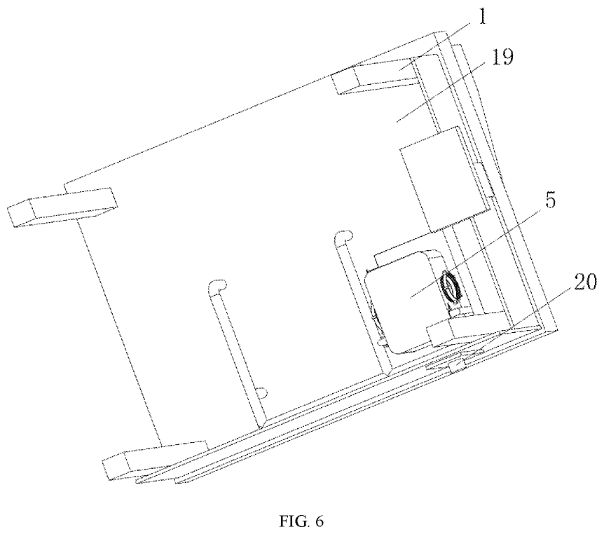

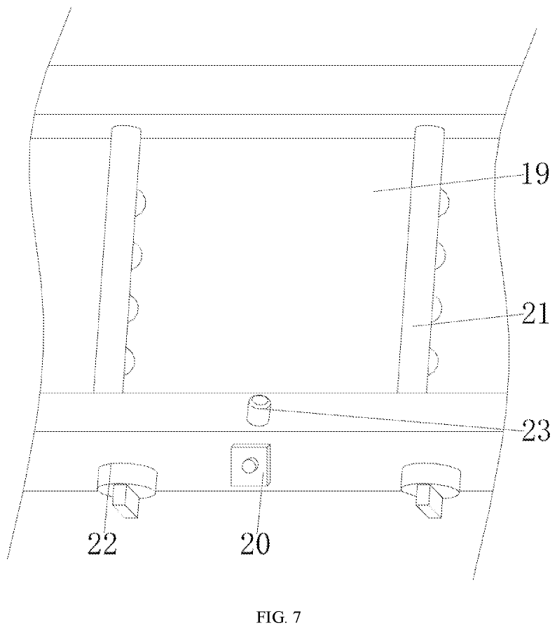

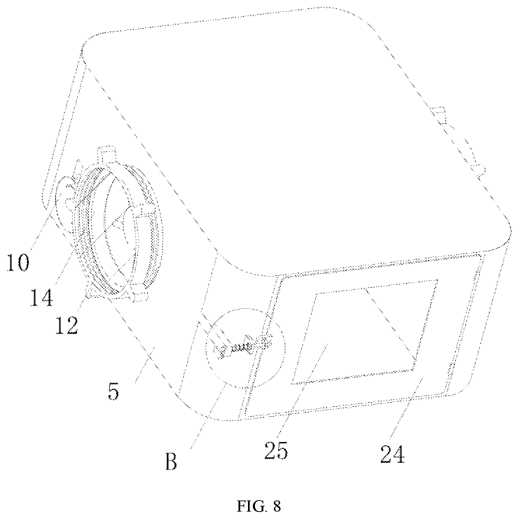

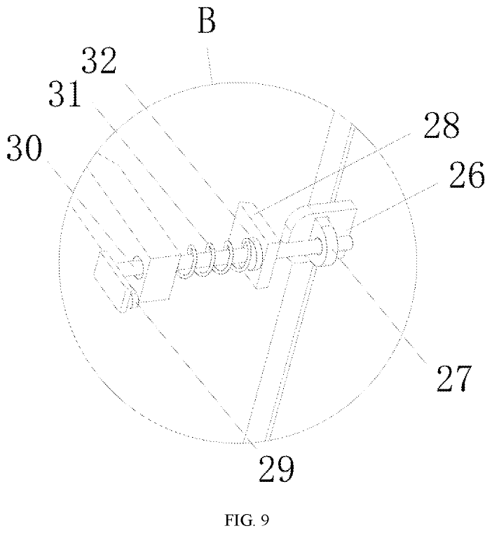

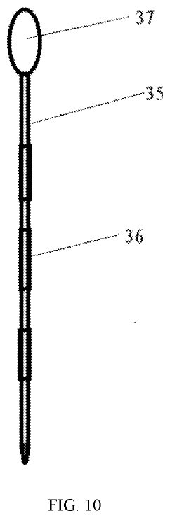

Referring to FIGS. 1-9, the present invention provides the following technical solutions: a multi-station parallel synchronous and asynchronous controller for a gas oven.

As shown in FIG. 1, the system includes N temperature sensors 20, the controller 1 and the proportional valve 23. The controller 1 determines whether to allow a station to join according to the actual time requirements of the station on the gas oven, and controls the opening and closing of the proportional valve 23. In actual use, the system sets the time interval for multiple stations to pass through the proportional valve 23 as the setting value, and defines the value as the system required value.

The detachable system includes a controller, a plurality of temperature sensors, a solenoid valve, a stepper motor, and a remote control terminal.

The plurality of temperature sensors are installed on a plurality of stations, respectively.

The controller generates a control signal, and sends the control signal to a driver through a communication network, so that the driver generates a driving signal according to the control signal, and sends the driving signal to a multi-station coordinated control system.

The multi-station controls the stepper motor and the solenoid valve of each station according to the drive signal.

A sensor is configured to collect position information and speed information of a plurality of target motors and generate a detection signal.

A multi-station coordinated control signal is pre-established according to the detection signal, so that the current driver adjusts the driving signal according to an adjusted control signal.

The multi-station coordinated control system receives the driving signal and outputs a current control command. A current control loop is configured to generate a current signal to at least one target stepper motor in the target motors according to the current control command to control the position and the speed of each target stepper motor in the target motors.

The target stepper motor includes a master stepper motor and a plurality of slave stepper motors. The master motor is configured to receive the current signal. The remote control terminal is further provided to perform control after communicating with a communication module through a mobile phone. The fixed base 2 is fixedly connected to a side of the controller 1, and the fixing bolt 3 is threadedly connected to the surface of the fixed base 2. An end of the fixing bolt 3 is threadedly connected to the mounting plate 4, and the mounting plate 4 is fixedly connected to the inner wall of the protective box 5. The positioning rod 6 is fixedly connected to the surface of the mounting plate 4, and the positioning base 7 is installed on the surface of the positioning rod 6. The positioning base 7 is fixedly connected to a side of the controller 1. Two through slots 8 are provided at sides of the protective box 5, respectively, and the exhaust fan 9 and the intake fan 10 are fixedly connected to the inner walls of the two through slots 8, respectively. The inner wall of the controller 1 is provided with the wiring harness hole 13, and the sealing ring 15 is slidably connected to the inner wall of the wiring harness hole 13. The compression spring 16 is fixedly connected to the surface of the protective box 5, and an end of the compression spring 16 is fixedly connected to the connecting plate 17. The sliding rod 18 is fixedly connected to the surface of the connecting plate 17, and an end of the sliding rod 18 is fixedly connected to the sealing ring 15. The top of the protective box 5 is fixed to the workbench 19, and the temperature sensors 20 are fixedly connected to the front of the workbench 19. Two hobs 21 and two solenoid valves 22 are fixedly connected to the top of the workbench 19, respectively, and the proportional valve 23 is fixedly connected to the top of the workbench 19.

In the present solution, by means of the cooperation between the fixed base 2 and the fixing bolt 3 and the cooperation between the positioning rod 6 and the positioning base 7, the controller can be quickly positioned, installed and fixed in use, thereby ensuring the stable performance of the controller, facilitating the installation or disassembly of the controller, and improving the practicability. The model of the controller 1 is FX3U-16MR/ES-A, and the model of temperature sensor 20 is PT100.

Specifically, the sealing door 24 is connected to the front of the protective box 5 by a hinge, and the observation window 25 is inlaid on the front of the sealing door 24.

In the present embodiment, the sealing door 24 is set to seal the front of the protective box 5, and the observation window 25 is inlaid on the front of the sealing door 24 to facilitate observing the inside of the protective box 5.

Specifically, the side of the protective box 5 is fixedly connected to the threaded base 11, the connecting base 12 is threadedly connected to the surface of the threaded base 11, and the dust screen 14 is installed on the inner wall of the connecting base 12.

In the present embodiment, the surface of the threaded base 11 is threadedly connected to the connecting base 12 to facilitate the disassembly and replacement of the dust screen 14.

Specifically, the connecting block 26 is fixedly connected to the front of the sealing door 24. The fixing block 27 is fixedly connected to the front of the protective box 5, and the fixing block 27 is adapted to the inner wall of the connecting block 26.

In the present embodiment, the fixing block 27 is adapted to the inner wall of the connecting block 26 to facilitate fixing the sealing door 24 and the protective box 5.

Specifically, two supporting bases 28 are fixedly connected to the front of the protective box 5, and the inserting rod 30 is slidably connected between the inner walls of the supporting bases 28. The inserting rod 30 is adapted to the size of the inner wall of the fixing block 27, and an end of the inserting rod 30 is fixedly connected to the fixed handle 29.

In the present embodiment, by means of the fixed handle 29 fixedly connected to an end of the inserting rod 30, the inserting rod 30 is conveniently pulled, and the position thereof can be limited.

Specifically, the supporting spring 31 is sleeved on the surface of the inserting rod 30. One end of the supporting spring 31 is fixedly connected to the fixed handle 29, and the other end of the supporting spring 31 is fixedly connected to the fixed ring 32. The fixed ring 32 is fixedly connected to the surface of the inserting rod 30.

In the present embodiment, by setting the supporting spring 31, the inserting rod 30 can be automatically reset by the rebound force.

Specifically, the surface of the protective box 5 is provided with the stabilizing groove 33. The stabilizing block 34 is slidably connected to the inner wall of the stabilizing groove 33, and the stabilizing block 34 is fixedly connected to the side of the connecting plate 17.

In the present embodiment, the stabilizing block 34 is slidably connected to the inner wall of the stabilizing groove 33, thereby improving the stability of the connecting plate 17 when moving.

Specifically, the controller 1, the temperature sensor 20, the solenoid valve 22 and the proportional valve 23 are all electrically connected by wires.

In the present embodiment, the temperature is sensed by the temperature sensor 20, and meanwhile, the food temperature sensor 36 is installed in the roasting stick 35 to sense the temperature of the food, sends a signal to the controller 1, and transmits the signal to the mobile phone APP. The controller 1 automatically controls the proportional valve 23 to open, so as to reasonably control the temperature.

The present invention further provides a method for using a multi-station parallel synchronous and asynchronous controller for a gas oven, including the following steps.

Step S1: first, when the controller 1 is installed, the positioning rod 6 is used to position the positioning base 7 fixed by the controller 1, and then, the fixing bolt 3 is twisted to fix the fixed base 2 on the surface of the mounting plate 4 to quickly fix the controller 1 inside the protective box 5.

Step S2: when the controller 1 dissipates the heat, the exhaust fan 9 is activated to extract and discharge the hot air inside the protective box 5, and then the intake fan 10 drives to take the cold air from the outside into the protective box 5, so that the hot air emitted by the controller 1 inside the protective box 5 can be ventilated and dissipated in time.

Step S3: when the wiring harness of the controller 1 is sealed, the compression spring 16 is moved upward through the connecting plate 17 to transmit the wiring harness of the controller 1 out of the inner wall of the protective box 5 through the wiring harness hole 13, and then, the connecting plate 17 is by released to tightly fit the sealing ring 15 fixed by the sliding rod 18 to the wiring harness of the controller 1 through the rebound force of the compression spring 16 to seal the surface of the wiring harness.

Step S4: when the hob 21 is controlled to work, the controller 1 is controlled by the application of the mobile phone to drive the solenoid valve 22 to ignite the hob 21, and the temperature is transferred to the controller 1 by the temperature sensors 20, and when the temperature is lowered, the proportional valve 23 is controlled by the solenoid valve 22 to increase the temperature.

By means of the cooperation between the fixed base and the fixing bolt and the cooperation between the positioning rod and the positioning base, the controller can be quickly positioned, installed and fixed in use, thereby ensuring the stable performance of the controller, facilitating the installation or disassembly of the controller, and improving the practicability.

When the multi-station parallel synchronous and asynchronous controller for the gas oven is used, the through slot, the exhaust fan and the intake fan cooperate to dissipate the heat emitted by the controller in use, thereby speeding up the circulation speed of air, and providing a good working environment for the controller.

When the multi-station parallel synchronous and asynchronous controller for the gas oven is used, the sealing ring, the compressed spring, the connecting plate and the sliding rod cooperate to enable the wiring harness of the controller to be limited, sealed and fixed in use. This ensures that the external water vapor will not enter into the protective box with the wiring harness, thereby avoiding damage to the controller.

Finally, it should be noted that: the above descriptions are only preferred embodiments of the present invention and are not intended to limit the present invention. Although the present invention has been described in detail with reference to the foregoing embodiments, for those skilled in the art, they can still perform modification on the technical solutions described in the foregoing embodiments, or made equivalent replacement to some of the technical features. Any modification, equivalent replacement and improvement made within the spirit and principle of the present invention shall fall within the scope of protection of the present invention.

What is claimed is:

1. A detachable multi-station parallel synchronous and asynchronous control system for a gas oven, comprising a controller, a plurality of temperature sensors, a solenoid valve, a stepper motor, and a remote control terminal; wherein
the plurality of temperature sensors are installed on a plurality of stations, respectively;
the controller generates a control signal, and the controller sends the control signal to a current driver through a communication network; the current driver generates a driving signal according to the control signal, and the current driver sends the driving signal to a multi-station coordinated control system;
the multi-station coordinated control system controls the stepper motor and the solenoid valve of each station of the plurality of stations according to the drive signal;
a sensor is configured to collect position information and speed information of a plurality of target motors and generate a detection signal; and
a multi-station coordinated control signal is pre-established according to the detection signal, and the current driver adjusts the driving signal according to an adjusted control signal.

2. The detachable multi-station parallel synchronous and asynchronous control system according to claim 1, wherein the multi-station coordinated control system receives the driving signal and outputs a current control command; a current control loop is configured to generate a current signal to at least one target stepper motor in the plurality of target motors according to the current control command, and the current control loop controls a position and a speed of each target stepper motor in the plurality of target motors.

3. The detachable multi-station parallel synchronous and asynchronous control system according to claim 1, further comprising a food temperature sensor matched with the controller, wherein temperature in the gas oven is controlled in a stepwise adjustment mode and a stepless linear adjustment mode.

4. The detachable multi-station parallel synchronous and asynchronous control system according to claim 2, wherein the each target stepper motor comprises a master stepper motor and a plurality of slave stepper motors, and the master motor is configured to receive the current signal.

5. The detachable multi-station parallel synchronous and asynchronous control system according to claim 4, further comprising a remote control terminal, wherein the remote control terminal is configured to perform control after communicating with a communication module through a mobile phone.

6. A method for using the detachable multi-station parallel synchronous and asynchronous control system according to claim 5, comprising:
step S1: when the controller is installed, using a positioning rod to position a positioning base fixed by the controller, and twisting a fixing bolt to fix the positioning base on a surface of a mounting plate to quickly fix the controller inside a protective box;
step S2: when the controller dissipates a heat, activating an exhaust fan to extract and discharge a hot air inside the protective box, and driving by an intake fan to take a cold air from an outside into the protective box, and ventilating and dissipating the hot air emitted by the controller inside the protective box in time;
step S3: when a wiring harness of the controller is sealed, moving a compression spring upward through a connecting plate to transmit the wiring harness of the controller out of an inner wall of the protective box through a wiring harness hole, and then, releasing the connecting plate to tightly fit a sealing ring fixed by a sliding rod to the wiring harness of the controller through a rebound force of the compression spring to seal a surface of the wiring harness; and
step S4: when a hob is controlled to work, controlling the controller by an application of a mobile phone to drive the solenoid valve to ignite the hob, and transferring a temperature to the controller by the plurality of temperature sensors, and when the temperature is lowered, controlling a proportional valve by the solenoid valve to increase the temperature.

7. A network stability control system based on the detachable multi-station parallel synchronous and asynchronous control system according to claim 1, wherein a fixed base is fixedly connected to a first side of the controller, and a fixing bolt is threadedly connected to a surface of the fixed base;
an end of the fixing bolt is threadedly connected to a mounting plate, and the mounting plate is fixedly connected to an inner wall of a protective box;
a positioning rod is fixedly connected to a surface of the mounting plate, and a positioning base is installed on a surface of the positioning rod; the positioning base is fixedly connected to a second side of the controller;
two through slots are provided at sides of the protective box, respectively, and an exhaust fan and an intake fan are fixedly connected to inner walls of the two through slots, respectively;
an inner wall of the controller is provided with a wiring harness hole, and a sealing ring is slidably connected to an inner wall of the wiring harness hole;
a compression spring is fixedly connected to a surface of the protective box, and an end of the compression spring is fixedly connected to a connecting plate;
a sliding rod is fixedly connected to a surface of the connecting plate, and an end of the sliding rod is fixedly connected to a sealing ring;
a top of the protective box is fixed to a workbench, and the plurality of temperature sensors are fixedly connected to a front of the workbench; and
two hobs and two solenoid valves are fixedly connected to a top of the workbench, respectively, and a proportional valve is fixedly connected to the top of the workbench.

8. The network stability control system according to claim 7, wherein a connecting block is fixedly connected to a front of a sealing door; a fixing block is fixedly connected to a front of the protective box, and the fixing block is adapted to an inner wall of the connecting block; two supporting bases are fixedly connected to the front of the protective box, and an inserting rod is slidably connected between inner walls of the two supporting bases; the inserting rod is adapted to a size of an inner wall of the fixing block, and an end of the inserting rod is fixedly connected to a fixed handle.

9. The network stability control system according to claim 8, wherein a supporting spring is sleeved on a surface of the inserting rod; a first end of the supporting spring is fixedly connected to the supporting base, and a second end of the supporting spring is fixedly connected to a fixed ring; and the fixed ring is fixedly connected to the surface of the inserting rod.

10. The network stability control system according to claim 8, wherein a surface of the protective box is provided with a stabilizing groove; a stabilizing block is slidably connected to an inner wall of the stabilizing groove, and the stabilizing block is fixedly connected to a side of the connecting plate.

11. The network stability control system according to claim 7, wherein the multi-station coordinated control system receives the driving signal and outputs a current control command; a current control loop is configured to generate a current signal to at least one target stepper motor in the plurality of target motors according to the current control command, and the current control loop controls a position and a speed of each target stepper motor in the plurality of target motors.

12. The network stability control system according to claim 7, further comprising a food temperature sensor matched with the controller, wherein temperature in the gas oven is controlled in a stepwise adjustment mode and a stepless linear adjustment mode.

13. The network stability control system according to claim 11, wherein the each target stepper motor comprises a master stepper motor and a plurality of slave stepper motors, and the master motor is configured to receive the current signal.

14. The network stability control system according to claim 13, further comprising a remote control terminal, wherein the remote control terminal is configured to perform control after communicating with a communication module through a mobile phone.
